(19) United States
(12) Patent Application Publication
(10) Pub. No.: US 2007/0206759 A1
(43) Pub. Date: Sep. 6, 2007

(54) Systems, methods, and apparatus to record conference call activity

(76) Inventor: Robert M. Boyanovsky, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/364,918

(22) Filed: Mar. 1, 2006

(51) Int. Cl. H04M 3/42

(52) U.S. Cl. 379/202.01

(57) ABSTRACT

Systems, methods and apparatus are disclosed to record conference call activity. An example method disclosed herein includes monitoring a conference call for an action item voice command, detecting the action item voice command, and storing a signal representative of the action item voice command in a memory.

### FIELD OF THE DISCLOSURE

This disclosure relates generally to conference calls, and, more particularly, to systems, methods, and apparatus to record conference call activity.

### BACKGROUND

Meeting organizers, project leaders, and/or business managers (hereafter “meeting facilitators”) frequently need to communicate with employees involved in various projects. Projects and/or sub-tasks associated with projects may include the efforts and/or cooperation of employees located within geographically separated parts of one or more organizations (e.g., company, business, not-for-profit organization, etc.). As a result, conference calls are a particularly useful management tool for meeting facilitators.

At the beginning of a conference call, participants typically call a telephone number and verbally introduce themselves to the other participants already engaged in the conference call. As the number of participants increases, the existing participants must strive to remember a large number of voices and their associated names. Additionally, those participants that call in to the conference late (e.g., after initial introductions have been completed) may not have the opportunity to hear participant introductions. Thus, they may not recognize who is speaking during subsequent times of the conference call. As a result, it may be necessary to interrupt the conference call meeting and interject various questions about who was (just) speaking.

The conference call allows the meeting facilitator and other project members to discuss project plans, project issues, and/or assign additional project tasks designed to accomplish various project objectives. Particular participants that are assigned action items (e.g., project tasks and/or sub-tasks) typically acknowledge acceptance of the task(s), communicate task objectives and deliverables, and/or communicate task start and/or end dates for which the task should be completed. The meeting facilitator or another participant maintains the burden of taking meeting notes and documenting which conference call participants are responsible for the various assigned tasks. This burden is particularly difficult when the number of participants is high. Such administrative tasks may distract the meeting facilitator and/or other note-taking participants from applying his or her talents to project problem solving and/or other expertise. Such tasks may also consume meeting time.

### BRIEF DESCRIPTION OF THE DRAWINGS

FIG. 1 is a schematic diagram illustrating an example system to record conference call activity.

FIG. 2 is an example portion of a database table of the example system to record conference call activity of FIG. 1.

FIG. 3 is an example portion of a flash table of the example system to record conference call activity of FIG. 1.

FIGS. 4, 5 and 6 are flow diagrams representative of example machine readable instructions which may be executed to implement the example system to record conference call activity of FIG. 1.

FIG. 7 illustrates an example user interface which may be displayed to a user of the example system of FIG. 1.

FIG. 8 is a schematic illustration of an example computer which may execute the programs of FIGS. 4, 5, and/or 6 to implement the example system to record conference call activity of FIG. 1.

### DETAILED DESCRIPTION

Systems, methods, and apparatus to record conference call activity are disclosed. An example method includes monitoring a conference call for an action item voice command, detecting the action item voice command, and storing a signal representative of the action item voice command in a memory. An example system includes a call receiver to connect conference call participants to a conference call, a voiceprint server to identify a conference call participant based on a voice signal, a voice-command server to identify a command recited by a conference call participant, the voice-command server configured to execute an action in response to the identified command, and a conference log server to save a log of conference call activity to a database.

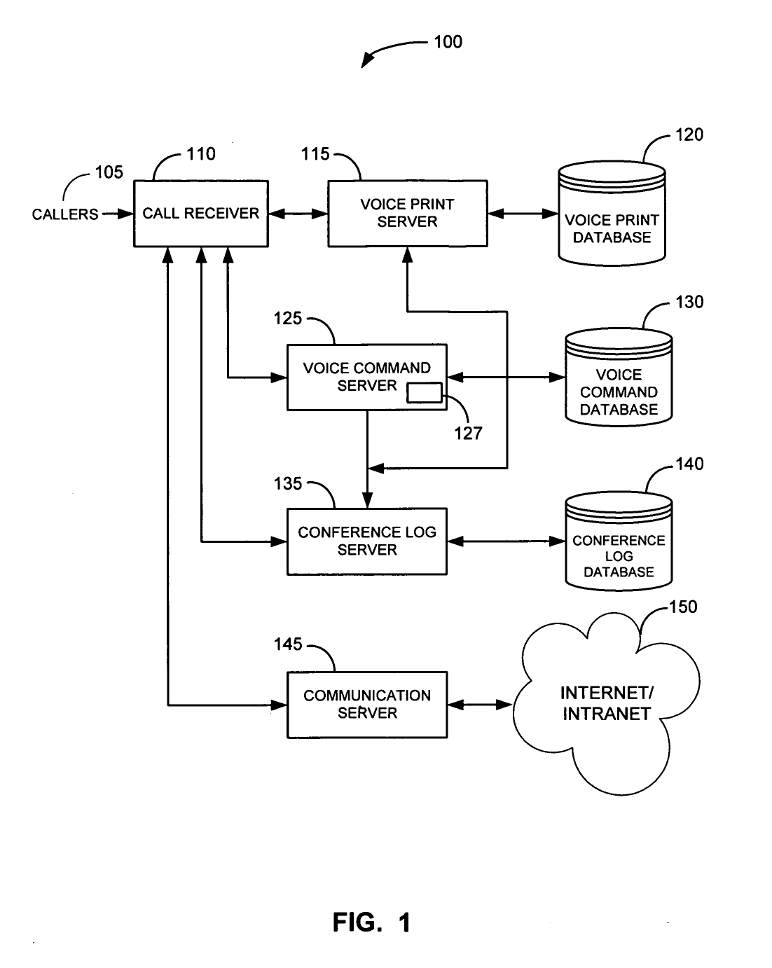

An example system 100 to record conference call activity is shown in FIG. 1. As mentioned above, callers 105 may dial a call-in telephone number to participate in a conference call. The call-in number may be dialed by all call participants and is, thus, referred to as a “common telephone number.” A call receiver 110 at, for example, a conference call center may be assigned the common telephone number. For example, the call receiver 110 may be a multi-line telephone or a conference bridge that permits the callers 105 from the same and/or diverse locations to be connected together. The conference bridge typically amplifies and/or balances audio signal levels for each of the callers so that every participant can hear and/or speak to each other during the conference call. The call receiver 110 may be located at a company associated with one or more of the conference call participants 105, or may be located at a third party conference call service provider such as AT&T.

The example system 100 of FIG. 1 also includes a voiceprint server 115 to identify callers 105 by their voices. For example, when a caller 105 dials in to the call receiver 110 and speaks their name and/or a password, the voiceprint server 115 converts the vocal information into an electronic proxy or signature (e.g., an analog signal such as a waveform having an amplitude and time axis, a digital value, etc.) that is unique to at least one aspect of the caller's voice (hereinafter “voiceprint”). The voiceprint server 115 of the illustrated example accesses a voiceprint database 120 to perform a search for an equivalent voiceprint (i.e., an electronic proxy substantially the same as the electronic proxy for the caller's voice signal). If such an equivalent voiceprint is found in the voiceprint database 120, then an identifier associated with the voiceprint is received from the voiceprint database 120. The identifier may be, for example, the caller's name, the caller's phone number, a pseudonym for the caller, etc. As discussed in further detail below, the voiceprint server 115 monitors the conference call for voiceprints to identify call participants, to associate conference call activities with identified callers, and/or to respond to voice commands.

If the voiceprint server 115 searches the voiceprint database 120 and fails to find a match, the voiceprint server 115 of the illustrated example permits the caller to associate their voice with their identity (i.e., to establish a voiceprint). For example, the voiceprint server 115 may, upon failing to find a voiceprint match, play a recording of instructions for the caller to follow. The recording may request that the caller recite one or more words designed to generate a unique voiceprint indicative of that caller. Alternately, such caller identification may be performed (or even be required to be performed) apart from a conference call (e.g., in a separate call to set up the service prior to the call.)

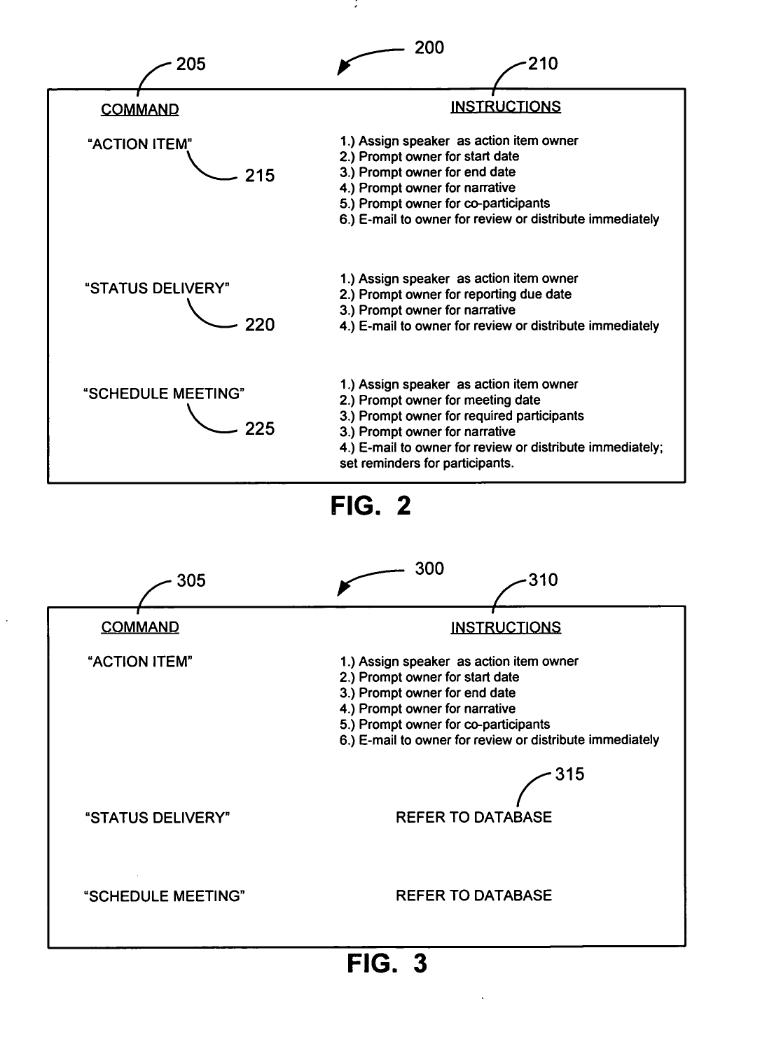

The example system 100 of FIG. 1 also includes a voice command server 125 to monitor the conference call for voice commands. The voice command server 125, which, in the illustrated example, is operatively connected to the call receiver 110, receives the same audio signals as the conference participants and compares received words and phrases extracted from those audio signals to specific/pre-determined commands previously stored in a voice command database 130. The voice command database 130 may contain one or more tables of commands, such as the example command table 200 shown in FIG. 2. The command table 200 of the illustrated example includes a command column 205 and an instruction column 210. The command column 205 includes entries identifying various verbal commands to which the voice command server 125 will respond. As shown in FIG. 2, the example command column 205 includes the example commands of “action item” 215, “status delivery” 220, and “schedule meeting” 225. Each example command corresponds to a list of one or more instructions to be executed in response to a participant's recitation of the corresponding command. The instructions are stored in the instruction column 210 adjacent to the corresponding commands. As discussed in further detail below, the meeting facilitator may view the complete list of voice commands via a graphical user interface (GUI) (e.g., a web-based GUI). Also discussed in further detail below, the meeting facilitator may edit, delete, and/or otherwise modify the functionality of the voice commands via the GUI.

The voice command server 125 of the illustrated example also includes a memory 127 (e.g., a flash memory) containing a list of some or all of the commands capable of being executed by the server 125. However, unlike the example voice command database 130, which contains all the commands and all corresponding instructions, the example memory 127 only includes the instructions for the most frequently used commands. In other words, the memory 127 does not include the instructions for less commonly used commands. This reduced instruction set may reduce response time after a command is spoken by a participant by eliminating a fetch to the voice command database 130. In the example of FIG. 3, the memory 127 includes an example local memory table 300. The example local memory table 300 includes a command column 305 and an instruction column 310, much like the command table 200 of FIG. 2. However, unlike FIG. 2, the local memory table 300 of FIG. 3 only includes instructions for the most frequently used commands. Such reduced command list minimizes memory size requirements of the (e.g., flash) memory 127, while still reducing command execution time. In particular, because most commands can be handled simply by acing the local memory table 300, the frequency at which the voice command server 125 queries the voice command database 130 is reduced. If a participant speaks a command that does not have a corresponding instruction in the instruction column 310 of the local memory table 300, a “refer to database” instruction 315 causes the voice command server 125 to query the voice command database 105 for the corresponding instructions. The local memory table 300 may be dynamic in that the set of commands with instruction can change based on usage patterns, or change based on modification by the meeting facilitator. In such an approach, a threshold metric may determine the instructions stored in the local memory table 300. Such threshold metrics may include, but are not limited to, a threshold number of recited commands per unit of time (e.g., a command recited by a participant more than two times within a 10-minute period), and a frequency weight of commands recited (e.g., the top 5 historically most frequently recited commands). Alternatively, the local memory table 300 may be static (e.g., pre-set based on typical usage pattern, estimated usage patterns, arbitrary usage patterns, meeting facilitator preferences, etc.).

The example system of FIG. 1 may accept voice commands from any of the call participants. However, because the example system 100 is able to identify callers based on voiceprints, it is also able to enforce an authorization policy wherein some speakers are permitted to issue certain commands, and/or some speakers are not permitted to issue certain commands. To this end, the system 100 may be programmed to place participants in authorization categories or levels. For example, a meeting facilitator or one or more other persons of high importance may have a maximum permitted level of authorization to issue voice commands. Thus, for example, the meeting facilitator may be permitted to issue commands that dictate when the conference call is over (e.g., a voice command “End Meeting”, commands to go off record, and/or other commands). Other conference call participants of lesser authority, such as mid-level managers, for example, may have a second/lower level of authorization that permits usage of a lesser number of commands during the conference call than the first authorized level. For example, mid-level managers may be permitted to issue voice commands such as “Action Item,” in which project tasks are assigned to various project members, but if they issue higher-level commands (e.g., an “End Meeting” command) the system 100 will not respond. Additionally or alternatively, if a meeting participant has a lower authorization level (no authorization), then such participants may merely listen to the other conference call participants, or contribute to meeting discussion, but any commands they issue will be disregarded by the system 100. Furthermore, if the meeting facilitator chooses to add and/or delete authorization levels during the meeting, the meeting facilitator may make such modifications in real-time via, for example, a web-based GUI. The meeting facilitator may also choose to publish a live list of meeting attendees for the other participants to view, or hide such participant list information, as needed.

Although the above example discusses these levels of authorization, persons of ordinary skill in the art will appreciate that other numbers of levels are likewise appropriate. Further, persons of ordinary skill in the art will appreciate that the example system 100 enforces the authorization policy by simply ignoring unauthorized commands from speakers and/or by issuing a sound or other signal light indicating the requested action is blocked by the authorization mechanism to verify that participants are aware their requested action was refused.

The example system 100 of FIG. 1 also includes a conference log server 135 to receive and record a chronological log of events and conversations that occur during the conference call. The example conference log server 135 of FIG. 1 includes a voice-to-text engine and saves converted text log data to a conference log database 140. The conference log server 135 is communicatively connected to the call receiver 110 and may, before converting voice-to-text, initiate a request to the voiceprint server 115 to determine if the voice belongs to an authorized participant. Alternatively, if a complete log is desired, the log server 135 may log all detected conversations during the call. As discussed in further detail below, if non-authorized voices are received by the call receiver, they may be ignored while still allowing such participants to listen.

Upon completion of the conference call, the call receiver 110 of the illustrated example instructs a communication server 145 to publish the conference log to, for example, one or more web pages accessible via the Internet and/or intranet 150 and/or to publish the log by forwarding the same to one or more e-mail addresses. For example, the communication server 145 may include a web and/or e-mail server which, additionally or alternatively, e-mails the conference log to the conference participants, to a selected subset thereof and/or to a third party (i.e., another call participant). Rather than immediately publishing the conference log to the Internet/intranet and/or e-mailing the log to the participants, a subset of the participants, and/or a non-participant, the example system 100 may allow the meeting facilitator to review, edit, and/or redact the conference log prior to publication. Log output formats may include, but are not limited to, Microsoft Word®, ASCII text, and/or Adobe® PDF.

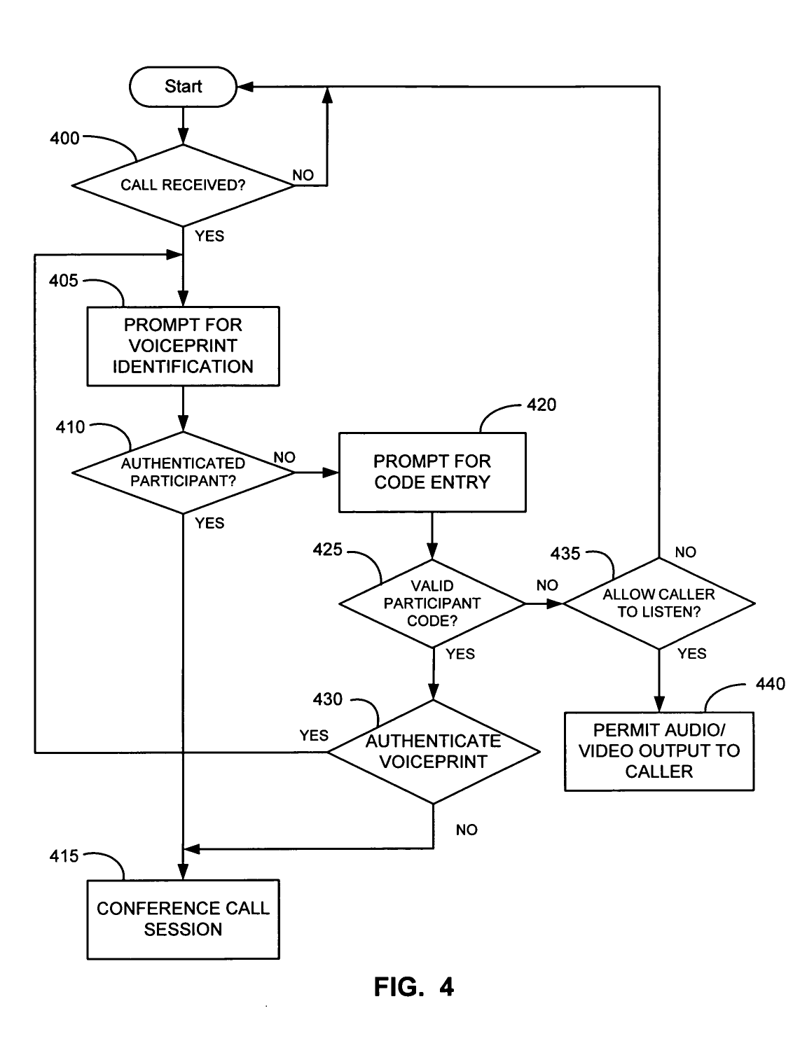

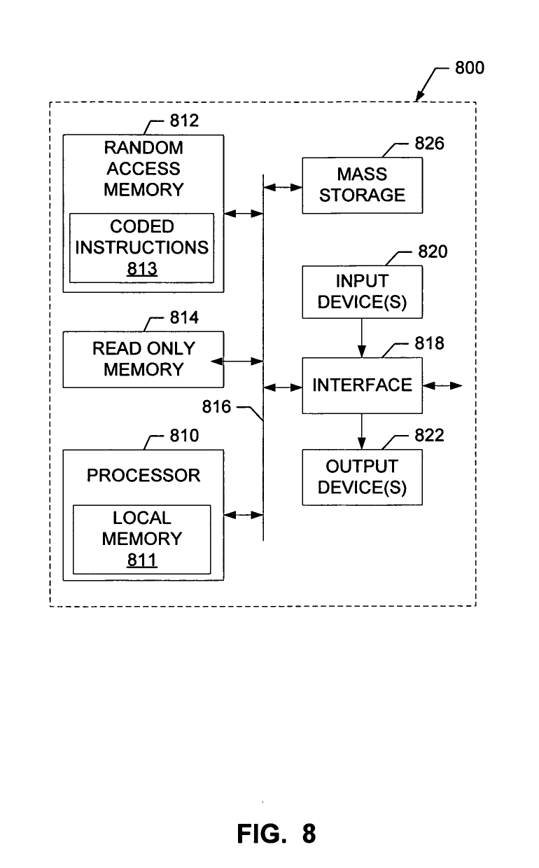

Flowcharts representative of example machine readable instructions for implementing the example system 100 to record conference call activity of FIGS. 1-3 are shown in FIGS. 4-6. In these examples, the machine readable instructions comprise a program for execution by: (a) a processor such as the processor 810 shown in the example computer 800 discussed below in connection with FIG. 8, (b) a controller, and/or (c) any other suitable processing device. The program may be embodied in software stored on a tangible medium such as, for example, a flash memory, a CD-ROM, a floppy disk, a hard-drive, a digital versatile disk (DVD), or a memory associated with the processor 810, but persons of ordinary skill in the art will readily appreciate that the entire program and/or parts thereof could alternatively be executed by a device other than the processor 810 and/or embodied in firmware or dedicated hardware in a well-known manner (e.g., it may be implemented by an application specific integrated circuit (ASIC), a programmable logic device (PLD), a field programmable logic device (FPLD), discrete logic, etc.). For example, any or all of the system 100 to record conference call activity, the call receiver 110, the voiceprint server 115, the voiceprint database 120, the voice command server 125, the voice command database 130, the conference log server 135, the conference log database 140, and the web communication server 145 could be implemented by software, hardware, and/or firmware. Also, some or all of the machine readable instructions represented by the flowcharts of FIGS. 4-6 may be implemented manually. Further, although the example program is described with reference to the flowcharts illustrated in FIGS. 4-6, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The program of FIG. 4 begins at block 400 where the example system 100 monitors one or more communication lines (e.g., telephone lines) for incoming calls. In particular, the call receiver 110 (e.g., a conference bridge) is assigned a telephone number on a telecommunication network that, when dialed, causes the network to communicatively connect the calling conference call participants 105 to the system 100. Alternatively, rather than providing each caller 105 with the telephone number assigned to the call receiver 110, the callers may be provided with alternate telephone numbers that are within their local calling area and/or toll-free numbers (e.g. 800 numbers). Persons of ordinary skill in the art will appreciate that the alternate telephone numbers may, via a service/signal control point (SCP) or similar device, route the calls to the call receiver 110 to communicatively connect callers 105 to the system 100 and to one another.

If no calls are received at block 400, then the program loops at predetermined intervals until a call is received. When a call is received (block 400), the voiceprint server 115 prompts the caller 105 to authenticate their voice and/or otherwise identify themselves (block 405). For example, the system 100 may, at block 405, play a recorded message requesting that the caller 105 speak their name and/or enter a passcode. The meeting facilitator may set-up the conference call such that all callers 105 must speak their names for authentication (block 410) before proceeding to, and/or participating in the conference call. For example, after the caller 105 speaks their name, the voiceprint server 115 queries the voiceprint database 120 for a corresponding voiceprint match. Such a voice sample may include the caller 105 reciting the alphabet, counting to ten, and/or reciting his or her name aloud. The representative vocal sample is saved in the voiceprint database 120 and used for later authentication purposes, as needed. Callers' 105 voices matching a voiceprint in the voiceprint database 120 are allowed entry to a conference call session 415, discussed below.

Callers' 105 voices without a matching voiceprint in the voiceprint database 120 may be disconnected or prompted for a passcode at block 420. For example, the meeting facilitator may allow callers 105 to participate in the conference call despite those callers not having a corresponding voiceprint in the voiceprint database 120 by providing them with a passcode. If the caller 105 enters the correct passcode (e.g., a 4-digit number sent to the prospective caller via e-mail) at block 425, then that caller may optionally have their voice authenticated by the system 100 at block 430 or may simply be allowed to participate in the call as a zero authorization participant (i.e., disallowing another to command the system 100 by voice). If the user authenticates their voice, the process may thereafter advance back to block 405 to test the new voiceprint. As discussed above, voiceprint authentication for a new caller 105 begins with the voiceprint server 115 requesting that the caller provide a representative sample of their voice. Upon completion of voiceprint authentication at block 430, the caller 105 is permitted to participate in the conference call session at block 415.

Returning to block 425, if the caller 105 fails to enter the correct passcode and/or does not know the passcode, the system 100 determines whether the caller may participate in the conference call at block 435. The meeting facilitator may allow callers 105 without a passcode to have limited or no access to the conference call. If the meeting facilitator configures the system to allow only callers 105 that have either an authenticated voiceprint and/or a valid passcode, then the system blocks the caller's 105 access (e.g., by disconnecting the unauthorized caller) (block 435) and resumes waiting for prospective participants (block 400). Alternatively, if the facilitator configures the system 100 to allow access for the caller 105 without a valid passcode, then the caller is permitted to listen to the conference call (block 440). The caller may be permitted to speak and listen during the call. Alternatively, the caller may be permitted to listen to the call but audio signals (e.g., voice) from the caller may be blocked. Such a configuration in which callers 105 may not fully participate (e.g., no speaking) are particularly useful to facilitate corporate announcements to employees (e.g., corporate reorganization announcements, quarterly finance announcements, etc.).

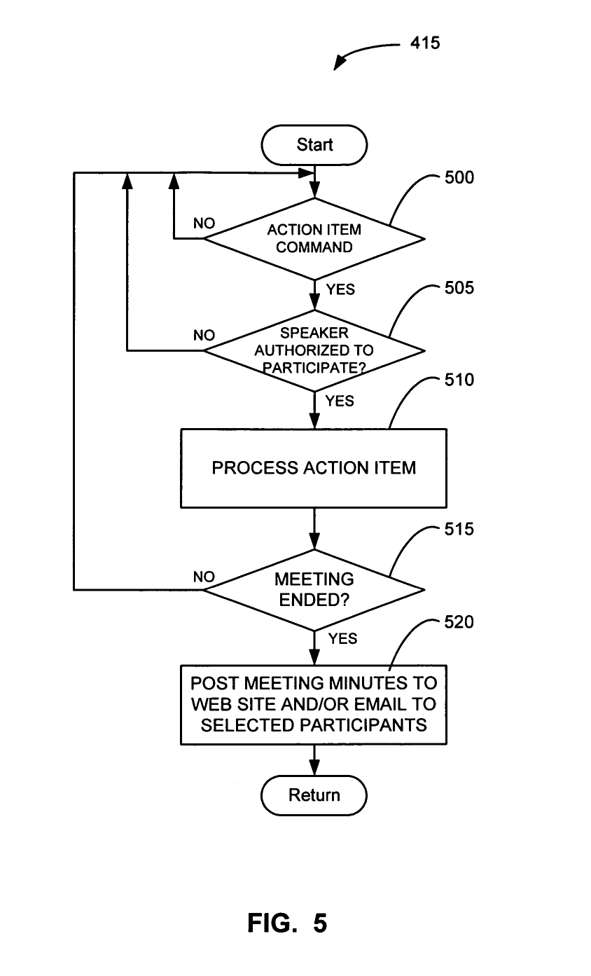

The example conference call session (block 415) of FIG. 4 is shown in further detail in FIG. 5. The program of FIG. 5 begins at block 500 where the example system 100 to log conference call activity monitors the voice signals associated with the call for action item commands. In particular, the voice command server 125 of the illustrated example receives audio signals corresponding to the participants' discussion, and determines whether a command has been issued by comparing the signals with entries in the voice command database 130 or the local memory 127. As discussed above in view of FIG. 2, the voice command database contains various commands in a command column 205 and associated command instructions in an instruction column 210. If a command is detected by the voice command server 125, program control advances from block 500 to block 505. Because some meeting participants may be authorized to invoke commands, while others may not, and/or have limited authorization, the voiceprint server 115 compares the voiceprint of the spoken command detected at block 500 to determine if the speaker is authorized to make the detected command.

If the voiceprint server 115 determines, after a query to the voiceprint database 120, that the speaker is not authorized to make the detected command, then program control returns to block 500 where the server 125 continues monitoring for action item commands. If, on the other hand, the voiceprint server 115 determines, after a query to the voiceprint database 120, that the speaker of the detected command is authorized to make the detected command, then program control advances to block 510, at which the instructions for the corresponding command are executed by the voice command server 125, as discussed in further detail below.

If the meeting has not ended, program control is directed from block 515 to block 500, where the system 100 continues to monitor for action item commands, as explained above. The conference call meeting may end via an action item command being recited by a suitably authorized participant, and/or the meeting may end as a result of all participants hanging up their telephones. If such a command to end the meeting is issued, or if all of the conference call participants hang-up (block 515), program control advances to block 520 in which minutes from the conference call are published to some or all of the meeting participants and/or to one or more designated third parties.

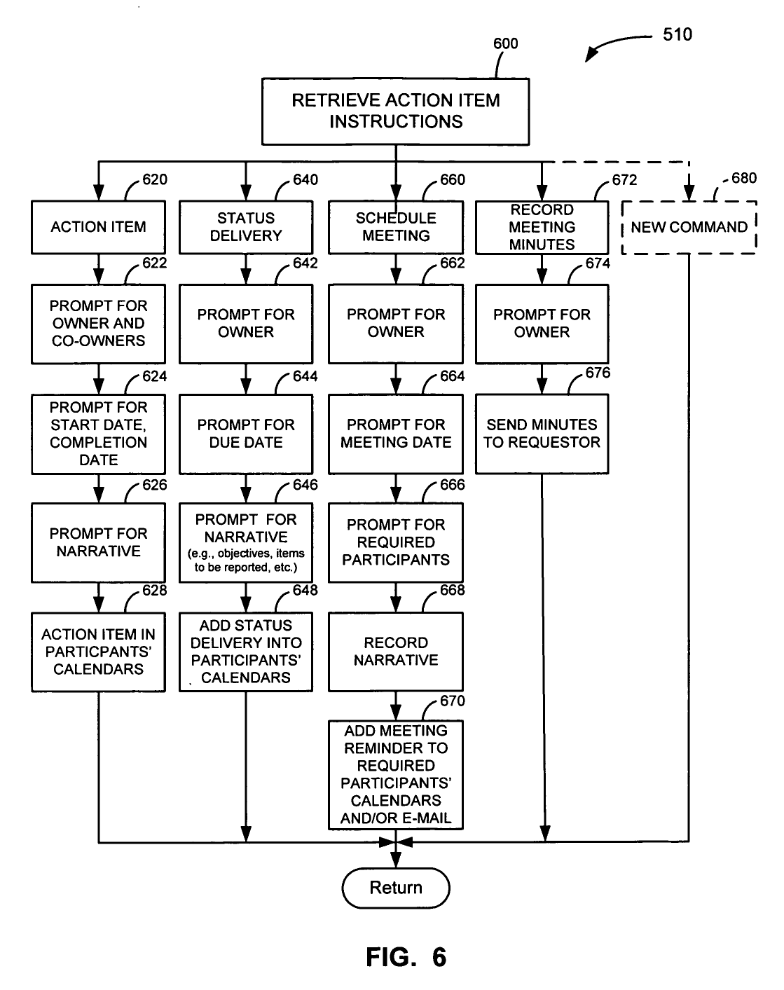

Additional details of the example program of block 510 are shown in FIG. 6. The example program begins at block 600 where the example system 100 retrieves instructions associated with the command recited by the speaker. In particular, the voice command server 125 branches program control to one of the recited commands including, but not limited to “action item” 620, “status delivery” 640, or “schedule meeting” 660. Commands in addition to (block 680), or instead of those illustrated in FIG. 6 may be programmed into the voice command server, as needed. Such commands may further permit automatic entry of the task to be entered into an on-line calendar. If the calendar is networked among other members of the project team (via Microsoft Outlook®, for example), then the command may also enter start dates, end dates, and/or task objectives in the calendar for every team member.

Returning to the example of FIG. 6, if, for example, the speaker recited “action item” during the conference call (and the speaker was determined to be authorized to invoke this command) then program control advances from block 600 to block 620. The example instructions for the “action item” command generally include assigning an individual with a particular task and/or responsibility, for which the responsible party is expected to attempt to accomplish the task objectives by a particular due date. Accordingly, the voice command server 125 prompts the conference call participants for the name of the action item owner, (e.g., the person held responsible) (block 622). For example, the voice command server 125 of the illustrated example plays a recorded message to the conference call participants that recites the phrase, “Please speak the name of the action item owner.” Similarly, the voice command server 125 may also play a message requesting that the name(s) of any co-participants be recited (block 622). Responses received by the voice command server 125 made by the speaker are converted to text by a speech-to-text engine included in, or operatively connected to, the voice command server 125. Speech-to-text engines, speech-to-text technologies, and voiceprint technologies (including voiceprint authentication) are generally known to persons of ordinary skill in the art and will not be discussed in detail herein. As discussed in further detail below, the text generated by the speech-to-text converter is representative of what conference call participants say and is saved to a conference log database 140 via the conference log server 135. As such, the names of action item owners and/or co-owners are saved to the conference log database 140 for further review by, for example, the meeting facilitator when the conference call ends.

The voice command server 125 of the illustrated example also plays a message to the conference call participants requesting start and completion dates (block 624). For example, the voice command server 125 may play a message that recites, “Please speak the month, day, and year for which this action item is to begin.” Similarly, the voice command server 125 may play a message that recites, “Please speak the month, day, and year for which this action item is due.”

Information regarding the responsibilities and/or task objectives (“narrative”) of the action item are then requested by the example system 100 of FIG. 1 (block 626). In particular, the voice command server 125 of the illustrated example plays a message to the conference participants that recites, for example, “Please describe task objectives and/or responsibilities after the tone. Press the pound-key when you are finished.” The words spoken by the conference participants are then converted from speech-to-text and saved to the conference log database 140.

Upon completion of the narrative at block 626, the example program of FIG. 6 advances to block 628 in which a flag is set to notify conference call participants of the new action item. For example, upon completion of the conference call, the meeting facilitator may review the conference log, which includes all commands that were invoked during the conference. The meeting facilitator may either approve in full, approve in part, or deny the flag that notifies the conference call participants of the action item. If the meeting facilitator approves, then some or all of the conference call participants and/or one or more designated persons that did not participate in the call will receive notification of the action item. Notification may include sending an e-mail message and/or adding the action item to the electronic calendars of the conference call participants. The individuals that receive the notifications may be selected, for example, by the meeting facilitator or may be identified to the system 100 with spoken commands during the call.

As discussed above, the voice command server 125 of the illustrated example may execute additional and/or alternative commands, such as a “status delivery” command, a “schedule meeting” command, and/or any other desired commands (block 680). An example status delivery command 640 is shown in FIG. 6. The example status delivery command 640 allows an authorized conference call participant to schedule and communicate an obligation to provide a project status update or similar information, at some future date. If the speaker recited “status delivery” during the conference call (and the speaker was determined to be authorized to invoke this command) then program control advances from block 600 to block 640. The voice command server 125 prompts the conference call participants for the name of the status delivery owner, (e.g., the person held responsible) (block 642). For example, the voice command server 125 of the illustrated example plays a recorded message to the conference call participants that recites the phrase, “Please speak the name of the status delivery owner.” Responses received by the voice command server 125 made by the speaker are converted to text by a speech-to-text engine included in, or operatively connected to, the voice command server 125. The text generated by the speech-to-text converter is representative of what conference call participants say and is saved to the conference log database 140 via the conference log server 135. Accordingly, the name of the status delivery owner is saved to the conference log database 140 for further review by, for example, the meeting facilitator when the conference call ends.

The voice command server 125 of the illustrated example also plays a message to the conference call participants requesting a due date for the status update (block 644). For example, the voice command server 125 may play a message that recites, “Please speak the month, day, and year for which this status update will be provided.”

Information regarding the information that will be disclosed (“narrative”) during the status update is then requested by the example system 100 of FIG. 1 (block 646). In particular, the voice command server 125 of the illustrated example plays a message to the conference participants that recites, for example, “Please describe the agenda and/or topics for which the status update will disclose. Press the pound-key when you are finished.” The words spoken by the conference participants are then converted from speech-to-text and saved to the conference log database 140.

Upon completion of the narrative at block 646, the example program of FIG. 6 advances to block 648 in which a flag is set to notify conference call participants of the new status update date. For example, upon completion of the conference call, the meeting facilitator may review the conference log, which includes all commands that were invoked during the conference. The meeting facilitator may either approve in full, approve in part, or deny the flag that notifies the conference call participants of the status update. If the meeting facilitator approves, then some or all of the conference call participants and/or one or more designated persons that did not participate in the call will receive notification of the status update. As discussed above, notification may include e-mail and/or adding the status update to the electronic calendars of the conference call participants.

An example “schedule meeting” command 660 is shown in FIG. 6. The example schedule meeting command 660 allows an authorized conference call participant to schedule a meeting for a future date. If the speaker recited “schedule meeting” during the conference call (and the speaker was determined to be authorized to invoke this command) then program control advances from block 660 to block 662. The voice command server 125 prompts the conference call participants for the name of the party responsible for the meeting, (e.g., another meeting facilitator) (block 662). For example, the voice command server 125 of the illustrated example plays a recorded message to the conference call participants that recites the phrase, “Please speak the name of the (new) meeting owner.” Responses received by the voice command server 125 made by the speaker are converted to text by a speech-to-text engine included in, or operatively connected to, the voice command server 125. The text generated by the speech-to-text converter is representative of what conference call participants say and is saved to the conference log database 140 via the conference log server 135. Accordingly, the name of the scheduled meeting owner is saved to the conference log database 140 for further review by, for example, the meeting facilitator when the conference call ends.

The voice command server 125 of the illustrated example also plays a message to the conference call participants requesting a meeting date for the scheduled meeting (block 664). For example, the voice command server 125 may play a message that recites, “Please speak the month, day, and year for which this meeting will be held.”

A prompt for required and/or desired meeting participants is issued by the voice command server 125 of the illustrated example (block 666). For example, the voice command server 125 of the illustrated example plays a message to the conference call participants that recites, “Please speak the names of required or desired attendees for this meeting.” The names recited are converted from speech-to-text and saved to the conference log database.

Information regarding the information that will be discussed and/or the meeting objectives (“narrative”) during the scheduled meeting are then requested by the example system 100 of FIG. 1 (block 668). In particular, the voice command server 125 of the illustrated example plays a message to the conference participants that recites, for example, “Please describe the agenda and/or topics for which the meeting will address. Press the pound-key when you are finished.” The words spoken by the conference participants are then converted from speech-to-text and saved to the conference log database 140.

Upon completion of the narrative at block 668, the example program of FIG. 6 advances to block 670 in which a flag is set to notify conference call participants of the new meeting date. For example, upon completion of the conference call, the meeting facilitator may review the conference log, which includes all commands that were invoked during the conference. The meeting facilitator may either approve in full, approve in part, or deny the flag that notifies the conference call participants of the meeting. If the meeting facilitator approves, then some or all of the conference call participants and/or one or more designated persons that did not participate in the call will receive notification of the meeting. As discussed above, notification may include e-mail and/or adding the meeting to the electronic calendars of the conference call participants.

An authorized participant may also invoke a “record meeting minutes” command (block 672) to record the dialog spoken by various meeting participants during the conference call. For example, upon the authorized participant invoking the “record meeting minutes” command, the voice command server 125 prompts the conference call participants for the person that is to receive the recorded minutes. Alternatively, the voice command server 125 may automatically determine the speaker's identity by sending the spoken command to the voiceprint server 115 (block 674). As such, the voiceprint server 115 may append the name of each speaker to the transcript next to the speaker's text. The voice command server 125 records words spoken by the various speakers and converts the voice information to text prior to storing the text data in the voice command database 130. Alternatively, the voice data may be stored in an audio format that includes, but is not limited to, audio video interleave (AVI), WAVE (WAV) format by Microsoft®, audio interchange file format (AIFF), Windows® media audio (WMA), and/or MPEG audio layer-3 (MP3) format. Storing the meeting minutes to the database in an audio format, rather than immediately converting voice-to-text, allows the system 100 to conserve computer processing resources for off-peak times. Alternatively, or additionally, the meeting facilitator may choose to receive both a transcript (e.g., log) of the meeting in text as well as the audio for subsequent review. Such transcript log(s) and/or audio files (e.g., MP3 files) may be e-mailed to the meeting facilitator after the conference ends (block 676). Of course, one or more fees may be charged for any of these services including fees for creating logs, for storing logs, for emailing or otherwise communicating logs, etc.

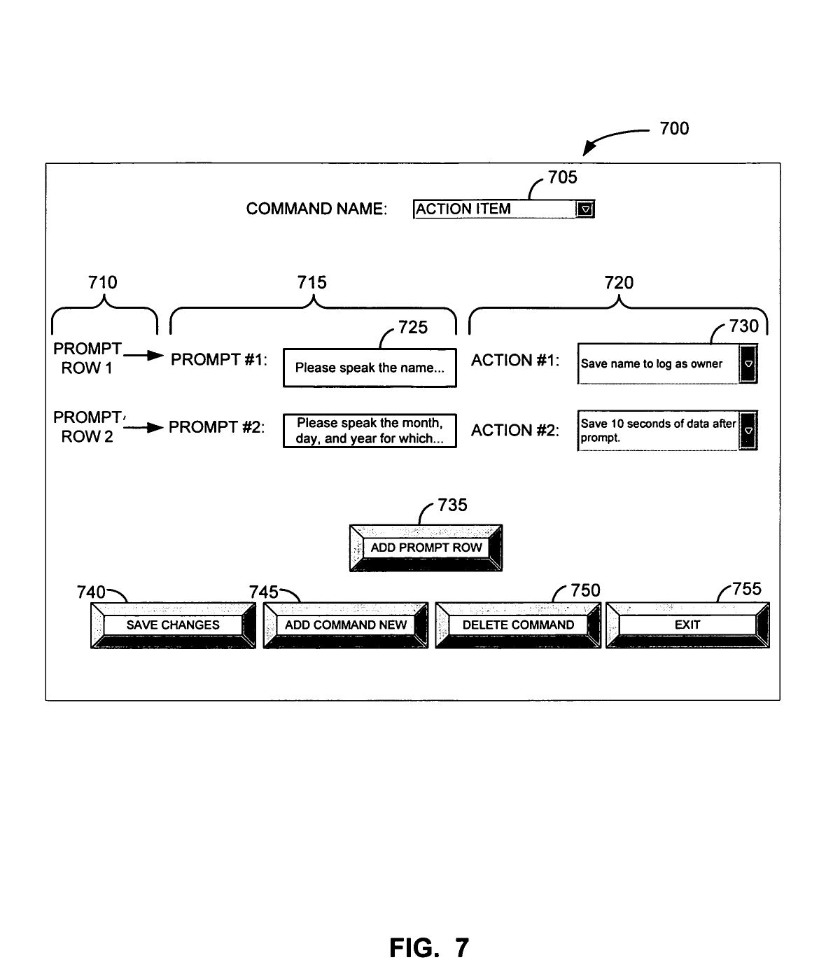

FIG. 7 is an example graphical user interface (GUI) 700 displayed by the example voice command server 125 of FIG. 1. When an authorized user (e.g., a technician associated with a telecommunication company, a conferencing technical assistant, a meeting facilitator, etc.) accesses the GUI 700, any of the existing commands and corresponding instructions may be edited, enabled, disabled, and/or deleted. Additionally, the GUI 700 provides the authorized user an option to create new commands, as needed.

The example GUI 700 of FIG. 7 includes a command name drop down menu 705 to provide the user with a list of commands to which the system 100 may respond. If the user selects a command within the drop down menu 705, then the corresponding instructions are populated in the various fields of the GUI 700, as discussed below. Depending on the number of interactive system prompts required by the selected command, the GUI 700 displays a corresponding prompt row 710. Each prompt row 710 includes a prompt field 715 and an action field 720. The prompt fields display language that the system 100 will recite to the conference call participants after the command is invoked. For example, the first prompt for the “action item” command 620, as discussed above in view of FIG. 6, causes the system 100 to play the phrase “Please speak the name of the action item owner,” shown in a field for prompt #1 (725). As shown in the example GUI 700 of FIG. 7, because the “action item” command is selected in the command name drop down menu 705, all of the prompts and corresponding actions (instructions) appear below and relate to the “action item” command. The corresponding action #1 (730) instructs the system 100 to save the name recited by a conference call participant to the log.

If the user chooses to edit the displayed command (e.g., the “action item” command), then the user may select any field and type-in or select changes. For example, the user may select an “add prompt row” button 735 to add more instructions to the command, and/or delete the contents of existing prompt row information to remove command instructions. Upon completion of any changes, the user may select a “save changes” button 740. Additionally, if the user has entered a new command name in the command name drop down menu 705 and entered corresponding prompts and actions, then the user may select an “Add Command New” button 745 to add the command to the list of commands to which the system 100 will respond. Still further, the user may delete any selected command by selecting a “Delete Command” button 750. If the user selects an “Exit” button 755, then the example GUI 700 exits without making any changes to the selected command.

FIG. 8 is a block diagram of an example computer 800 capable of implementing the apparatus and methods disclosed herein. The computer 800 can be, for example, a server, a personal computer, a laptop, a PDA, or any other type of computing device.

The computer 800 of the instant example includes a processor 810 such as a general purpose programmable processor. The processor 810 includes a local memory 811, and executes coded instructions 813 present in the local memory 811 and/or in another memory device. The processor 810 may execute, among other things, the example machine readable instructions illustrated in FIGS. 4-6. The processor 810 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 810 is in communication with a main memory including a volatile memory 812 and a non-volatile memory 814 via a bus 816. The volatile memory 812 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 814 may be implemented by flash memory and/or any other desired type of memory device. Access to the main memory 812, 814 is typically controlled by a memory controller (not shown) in a conventional manner.

The computer 800 also includes a conventional interface circuit 818. The interface circuit 818 may be implemented by any type of well known interface standard, such as an Ethernet interface, a universal serial bus (USB), and/or a third generation input/output (3GIO) interface.

One or more input devices 820 are connected to the interface circuit 818. The input device(s) 820 permit a user to enter data and commands into the processor 810. The input device(s) can be implemented by, for example, a keyboard, a mouse, a touchscreen, a track-pad, a trackball, isopoint and/or a voice recognition system.

One or more output devices 822 are also connected to the interface circuit 818. The output devices 822 can be implemented, for example, by display devices (e.g., a liquid crystal display, a cathode ray tube display (CRT), a printer and/or speakers). The interface circuit 818, thus, typically includes a graphics driver card.

The interface circuit 818 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 826 for storing software and data. Examples of such mass storage devices 826 include floppy disk drives, hard drive disks, compact disk drives and digital versatile disk (DVD) drives. The mass storage device 826 may implement the voiceprint database 120, the voice command database 130, and/or the conference log database 140.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for conference call management comprising:
monitoring a conference call for an action item voice command;
detecting the action item voice command; and
storing a signal representative of the action item voice command in a memory.

2. A method as defined in claim 1 wherein monitoring a conference call further comprises monitoring audio signals associated with a plurality of conference call participants.

3. A method as defined in claim 1 further comprising receiving a call from a conference participant.

4. A method as defined in claim 3 wherein the call is received at a conference bridge.

5. A method as defined in claim 1 further comprising identifying a conference call participant based on the signal representative of the action item voice command.

6. A method as defined in claim 1 further comprising excluding a participant without an authenticated voice signature from participating in the conference call.

7. A method as defined in claim 6 wherein excluding the participant without the authenticated voice signature comprises disconnecting the participant from the conference call.

8. A method as defined in claim 6 wherein excluding the participant without the authenticated voice signature comprises blocking the participant from transmitting voice but allowing the participant to listen to the conference call.

9. A method as defined in claim 1 further comprising converting the action item voice command to text.

10. A method as defined in claim 9 further comprising broadcasting the text to one or more communication devices.

11. A method as defined in claim 1 wherein the action item voice command comprises one or more associated tasks assigned to one or more individuals.

12. A method as defined in claim 1 further comprising broadcasting an action item list including at least one action item specified by the action item voice command.

13. A method as defined in claim 1 further comprising generating a log of conference call activity.

14. A method as defined in claim 13 wherein the log of conference call activity further comprises at least one of a list of recited action items or meeting minutes.

15. A method as defined in claim 14 further comprising associating a conference call participant with at least one of the list of recited action items or the meeting minutes.

16. An article of manufacture storing machine readable instructions which, when executed, cause a machine to:
monitor a conference call for an action item voice command;
detect the action item voice command; and
store a signal representative of the action item voice command in a memory.

17. An article of manufacture as defined in claim 16 wherein the machine readable instructions further cause the machine to exclude a participant without an authenticated voice signature from participating in the conference call.

18. An article of manufacture as defined in claim 16 wherein the machine readable instructions further cause the machine to convert the action item voice command to text.

19. An article of manufacture as defined in claim 18 wherein the machine readable instructions further cause the machine to broadcast the text to one or more conference co-participants.

20. A system to record conference call activity comprising:
a call receiver to connect conference call participants to a conference call;
a voiceprint server to identify a conference call participant based on a voice signal;
a voice-command server to identify a command recited by a conference call participant, the voice-command server configured to execute an action in response to the identified command; and
a conference log server to save a log of conference call activity to a database.

21. A system as defined in claim 20 further comprising a communication server to publish the log of conference call activity to the conference call participants.

22. A system as defined in claim 20 wherein the call receiver comprises a conference bridge.

23. A system as defined in claim 20 wherein the voiceprint server further comprises a voiceprint database to store the voiceprint of the authorized participant.

24. A system as defined in claim 20 wherein the voice-command server further comprises a command table to store a plurality of conference call commands and corresponding instructions.

25. A system as defined in claim 24 further comprising a database to store the command table.

26. A system as defined in claim 20 wherein the voice-command server further comprises a local memory to store a plurality of conference call commands and a subset of corresponding instructions.

27. A system as defined in claim 26 wherein the corresponding instructions stored in the local memory are dynamically selected in accordance with a threshold metric.

28. A system as defined in claim 27 wherein the threshold metric comprises at least one of a number of times the command is recited per unit of time or a frequency weight.

29. A system as defined in claim 20 wherein the conference log server further comprises a speech-to-text engine to convert voice signals to text.

30. A system as defined in claim 20 wherein the voice-command server executes the action if the call participant speaking the identified command is identified as having authority to issue the command in an authorization log.

31. A user interface for a conference call management system comprising:
a voice command configuration screen area to display at least one of a plurality of conference call voice command instructions; and
a plurality of user selectable buttons to at least one of add, delete, or modify at least one of a plurality of the conference call voice command instructions.
